(19) United States
(12) Patent Application Publication
(10) Pub. No.: US 2022/0371343 A1
(43) Pub. Date: Nov. 24, 2022

(54) PRINT SUBSTRATE TRANSPORT SYSTEM AND METHOD

(71) Applicant: HEWLETT-PACKARD DEVELOPMENT COMPANY, L.P., Spring, TX (US)

(72) Inventors: Daniel Gutierrez Garcia, Sant Cugat del Valles (ES); Adria Olmos Marin, Sant Cugat del Valles (ES); Albert Estella Aguerri, Sant Cugat del Valles (ES)

(73) Assignee: HEWLETT-PACKARD DEVELOPMENT COMPANY, L.P., Spring, TX (US)

(21) Appl. No.: 17/772,045

(22) PCT Filed: Nov. 27, 2019
(86) PCT No.: PCT/US2019/063715

§ 371 Date: Apr. 26, 2022

(51) Int. Cl. B41J 15/16

(52) U.S. Cl. CPC B41J 15/16

(57) ABSTRACT

A print substrate transport system comprises a print substrate supply mechanism and a tensioner. The print substrate supply mechanism is configured to advance print substrate to a printing zone in a discontinuous motion. The tensioner is provided downstream of the print printing zone and is configured to guide a path of the print substrate from the printing zone to a post-processing zone, to control tension in the print substrate in the post-processing zone, and to convert the discontinuous motion of the substrate to continuous motion. A print substrate transport method comprises supplying a print substrate to a printing zone in a discontinuous motion, controlling a tension of the print substrate on a path downstream of the printing zone and converting the motion of the substrate from the discontinuous motion to a continuous motion.

### BACKGROUND

A printing process may comprise a post-processing stage, wherein the printing liquid that is deployed on a print substrate is dried and/or cured. For example, in a printer that uses latex-based printing liquids, the printed substrate may be dried to remove water and/or solvents from the printing liquid and/or cured to polymerize the printing liquid and create a film to protect the printed substrate. The printer may use an energy source such as a heater for drying and/or curing the printing liquid.

A method of drying and/or curing a printed substrate may comprise heating high pressurised air in a chamber, and then blowing the heated pressurised air onto the printed substrate, for example through a plurality of holes in a plate.

A printer that uses latex-based printing liquids may be a roll-to-roll printer, wherein the substrate to be printed is provided on a supply roller, and a print path of the substrate extends from the supply roller to a collecting roller. On the print path, the substrate may pass through a printing zone, wherein the latex-based printing liquids are applied to the substrate, and a post-processing zone, wherein the printed substrate is cured and/or dried, before being collected on the collecting roller.

### BRIEF DESCRIPTION OF THE DRAWINGS

FIG. 1 is an illustration of an example printer comprising a print substrate transport device, wherein the printer is in a first state;

FIG. 2 is an illustration the example printer of FIG. 1, wherein the printer is in a second state;

FIG. 3 is a graphical representation of the velocity of the substrate at different regions of an example print substrate transport device:

FIG. 4 is a graphical representation of the radius and rotational velocity of a collecting roller, and

FIG. 5 is a flow chart of an example method.

### DETAILED DESCRIPTION

In an example printing method, a substrate is advanced into a printing zone, wherein printing liquid is printed onto the substrate. The substrate may be advanced through the printing zone in steps, such that the movement of the substrate in the printing zone is stopped while a print carriage passes over the print substrate to apply printing liquid to a first region of the substrate. The substrate may then advance and may then stop again while the print carriage applies printing liquid to a subsequent region of the substrate.

The printed substrate may then be advanced into a post-processing zone, wherein heated, pressurized air is blown through holes in a plate, onto the printed substrate to dry and/or cure the printed substrate. If the printed substrate is advanced through the post-processing zone in the same discontinuous motion as it is advanced through the print zone, the print substrate may not be evenly dried and/or cured, which may impact the image quality of the printed substrate.

Examples described herein may enable a printed substrate to be advanced uniformly through a post-processing zone.

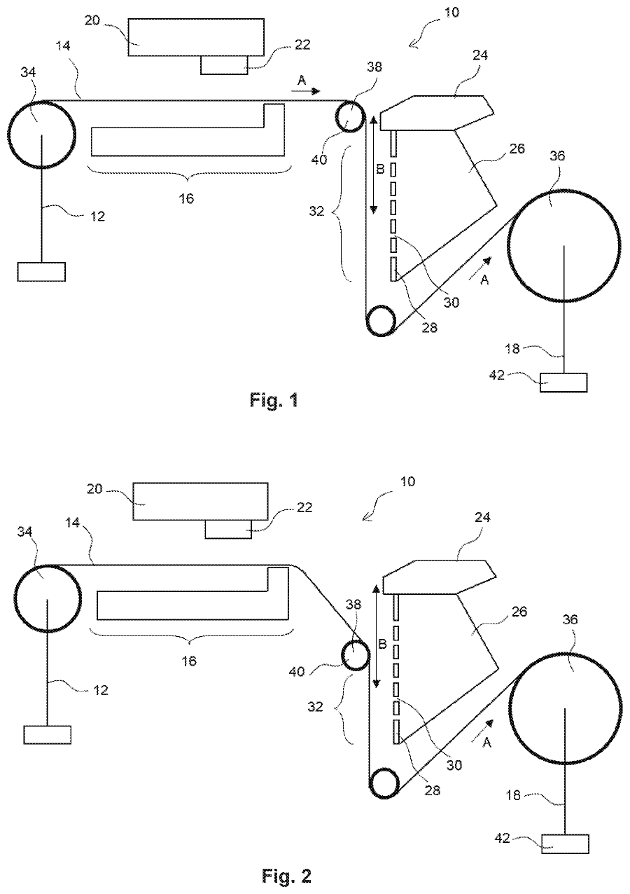

FIG. 1 shows an example printer 10 comprising a print substrate transport device. The print substrate transport device comprises a print substrate supply mechanism 12. The print substrate supply mechanism 12 is configured to advance print substrate 14 to a printing zone 16 in a discontinuous motion. The print substrate transport device may comprise a print substrate collection mechanism 18. The print substrate collection mechanism 14 may be configured to collect print substrate 16 in a continuous motion.

The printer comprises a print engine 20. The print engine 20 may be configured to apply printing liquid to the print substrate 14, for example latex-based printing liquid. The print engine 20 may comprise a print carriage 22. The print carriage 22 may be configured to pass over the width of the print substrate 14, in a direction substantially perpendicular to the advancing direction of the print substrate 14, indicated by arrows A. As the print carriage 22 passes over the print substrate 14, the carriage 22 may apply printing liquid to the print substrate 14.

The printer 10 comprises a post-processing apparatus 24. The post-processing apparatus 24 may comprise a chamber 26 having a heater, wherein pressurised air is heated by the heater within the chamber 26. The post-processing apparatus 24 may comprise a plate 28 having a plurality of apertures 30 provided therein, across the surface of the plate 28. The post-processing apparatus 24 may be configured to blow the heated, pressurised air through the apertures 30 in the plate 28 towards the printed substrate 14, to dry and/or cure the printing liquid on the printed substrate 14. The plate 28 may be positioned within the printer 10 so that it is substantially parallel to the print substrate 14 in a post-processing zone 32.

In other examples, the post-processing apparatus 24 may be configured to dry and/or cure the printed substrate 14 by different means, for example through UV or infrared radiation, or conduction.

The print substrate supply mechanism 12 may be configured to drive a supply roller 34. The supply roller 34 may be configured to operate in a rotating state and a non-rotating state. In the rotating state, the supply roller 34 may be driven to advance the print substrate 14 in the direction A towards the printing zone 16. In the non-rotating state, the supply roller 34 may prevent movement of the print substrate 14 in the printing zone 16.

The print substrate collection mechanism 18 may be configured to drive a collecting roller 36. In use, print substrate 14 may be provided between the supply roller 34 and the collecting roller 38 in a continuous path, so that a first end of the substrate 14 is attached to the supply roller 34 and a second end of the substrate 14 is attached to the collecting roller 38.

The print substrate transport system comprises a tensioner 38. The tensioner 38 is configured to guide the path of the print substrate 14 downstream of the printing zone 16 and to control a tension in the print substrate 14 in the post-processing zone 32. The tensioner 38 may be configured to guide the path of the print substrate 14 so that the print substrate 14 moves parallel to the plate 28 in the post-processing zone 32.

The tensioner 38 is configured to convert the discontinuous motion of the print substrate 14 from the supply mechanism 12 to a continuous motion.

The tensioner 38 may comprise a tensioner roller 40. The tensioner roller 40 may extend in the width direction of the print substrate 14, substantially perpendicular to the direction of advancement A of the print substrate 14 and may be configured to guide the path of the substrate 14 in the post-processing zone 32.

The tensioner roller 40 may be configured to move between a first position and a second position. For example, when the print substrate 14 advances through the printing zone 16, the tensioner roller 40 may move to an upper position shown in FIG. 1, and when the print substrate 14 stops motion in the printing zone 16, whilst printing liquid is being applied to the print substrate 14, the tensioner roller 40 may move towards the second position, shown in FIG. 2. This may alter the path of the print substrate 14 by changing the length of the path between the supply roller 34 and the collecting roller 36, to compensate for the stop in motion of the substrate 14 through the printing zone 16. The tension in the substrate 14 when the substrate 14 moves through the printing zone 16 stops may thereby be maintained, and the substrate 14 may continue to move uniformly through the post-processing zone 32.

The tensioner roller 40 may be an idle roller or may be a driven roller. The tensioner roller 40 may be biased to the first position and may be movable towards the second position by a force acting against the biasing force. The force acting against the biasing force may be provided by the tension in the substrate. For example, when the supply roller 34 is in a non-rotating state and the print substrate 14 stops moving in the printing zone 16, the collecting roller 36 may continue to be driven, which may increase tension in the substrate 14 that will force the tensioner roller 40 to move against the biasing force towards the second position shown in FIG. 2. When the supply roller 34 begins to rotate again, the tension in the substrate 26 will initially decrease, and so the biasing force will move the tensioner roller 40 up towards the first position.

The tensioner roller 40 may be biased to the first position by a spring, a gas spring, or a pneumatic actuator. In another example, the tensioner roller 40 may be biased into a first position by its own weight.

In another example, the position of the tensioner roller 40 may be movable between the first and second positions by a motor, for example a motorised arm connected to the tensioner roller 40.

As shown in FIGS. 1 and 2, the tensioner roller may be movable in a direction indicated by arrow B, parallel to the plate 28 and may guide the printed substrate 14 parallel to the plate 28.

In an example, the tensioner 38 may comprise a plurality of rollers, for example in a dancer arrangement. One or more of the plurality of rollers may be movable, such that the distance between the plurality of rollers can be altered, thereby adjusting the length of the path between the supply roller and the collecting roller.

The movement of the tensioner roller 40 may allow the substrate to move through the post-processing zone 32 at a constant velocity. This may correspond to the linear velocity of the collecting roller 38. The tensioner roller 40 may move in the direction B parallel to the plate 28 to maintain the velocity of the substrate 14 through the post-processing zone 32 at a substantially constant velocity.

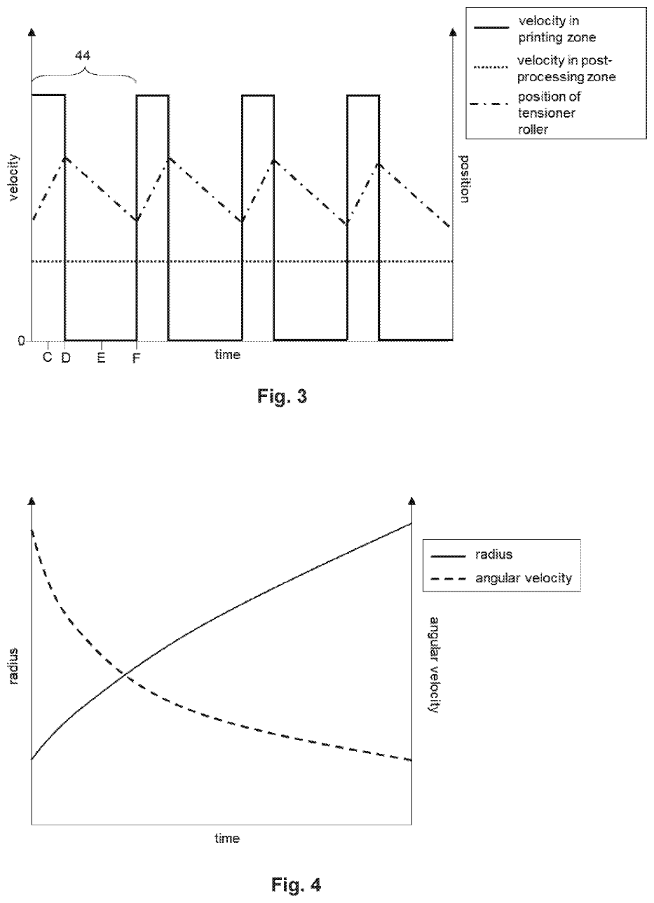

An example velocity profile of the substrate through the printing zone and through the post-processing zone 32 is shown in FIG. 3. FIG. 3 also shows a position profile of the tensioner roller 40 over the same time period. Points C, D, E and F indicate different times in one cycle 44 of the printer. At time point C indicated in FIG. 3, the supply roller 34 rotates and the substrate 14 advances through the print zone 16, the tensioner roller 40 is released and moves parallel to the plate 28 towards the first position, increasing the length of the substrate 14 that is adjacent the plate 28, and thereby increasing the area of the substrate 14 that is dried and/or cured. At point D, the tensioner roller 40 is in the first position, as indicated in FIG. 1, and the rotating movement of the supply roller stops. At point E, the supply roller 34 is in a non-rotating state and so the velocity of the substrate 14 in the printing zone 16 is zero; the collecting roller 38 continues to be driven by the print substrate collection mechanism 18, and so the substrate 14 adjacent the plate 28 continues to move at a constant speed. At point F, the tensioner roller 40 has moved to the second position, shown in FIG. 2. As the supply roger 34 begins to rotate again, the process is repeated.

As the collecting roller 36 collects the printed substrate 14 in a printing operation, its radius may increase, due to the increasing amount of print substrate 14 collected on the collecting roller 36. The rotational velocity at which the print collection mechanism 18 may drive the collecting roller 36 may be adjusted correspondingly, as indicated by the graphical representation in FIG. 4, in order to maintain a constant linear velocity of the substrate in the post-processing zone 32.

The print substrate transport system may be configured to advance printed substrate 14 through the post-processing zone 32 at a velocity that is substantially the average velocity of the print substrate 14 in the printing zone 16. This may be achieved by adjusting the rotational velocity at which the print collection mechanism 18 drives the collecting roller, so that the linear velocity of the collecting roller 36 is substantially constant and substantially the average velocity of the print substrate 14 in the printing zone 16.

The printer 10 may comprise a controller 42. In an example, the controller may be part of the print collection mechanism 18. The controller 42 may be configured to adjust the rotation speed of the driver of the collecting roger 36.

The controller 42 may receive information relating to the velocity of the print substrate through the printing zone 16. For example, the controller 42 may receive the information from the printing supply mechanism 12 that drives the supply roller 34. The controller 42 may adjust the rotation speed at which the print substrate collection mechanism 18 drives the collecting roller 36 according to the received information.

In another example, the controller 42 may be configured to receive information relating to the velocity of the print substrate 14 through the post-processing zone 32 and may be configured compare the velocity of the print substrate 14 through the post-processing zone 32 with a predetermined velocity. The controller 42 may be configured to adjust the rotation velocity of the collecting roller according to the comparison. The controller 42, with the tensioner 38, may thereby control the tension of the print substrate 14.

The substrate transport system may comprise a sensor. The sensor may be configured to provide velocity and/or position information to the controller 42. The sensor may be configured to sense the velocity of the print substrate 14 in the post-processing zone 32. In another example, the sensor may be configured to sense the position of the print substrate 14, and the controller 42 may be configured to determine the velocity of the print substrate 14 through the post-processing zone 32 based on the position. The sensor may be provided in the tensioner roller 40.

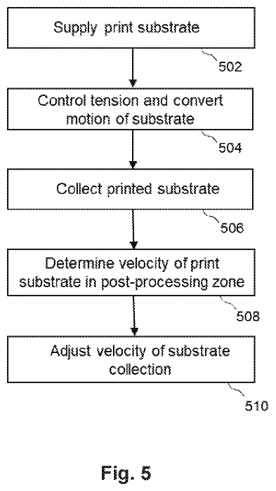

FIG. 5 shows a flowchart of an example method. The method may be executable by the print 10 shown in FIGS. 1 and 2.

The method comprises, in block 502, supplying a print substrate to a printing zone in a discontinuous motion. The print substrate may be supplied in a discontinuous motion by driving a supply roller in a rotating state, and preventing the rotation of the roller in a non-rotation state.

The method comprises, in block 504, controlling the tension of the print substrate and converting the motion of the print substrate from the discontinuous motion to a continuous motion. Controlling the tension of the print substrate and converting the motion of the print substrate from the discontinuous motion to the continuous motion may comprise moving a tensioner roller to alter a path of the substrate. For example, the tensioner roller may be moved in a direction parallel to a plate of a post-processing apparatus.

The method may comprise, in block 506, collecting the print substrate in the continuous motion. Collecting the print substrate in the continuous motion may comprise rotating a collecting roller.

The method may comprise, in block 508, determining a velocity of the print substrate through the post-processing zone. The method may comprise comparing the measured velocity with a predetermined velocity.

The method may comprise, in block 510, adjusting a velocity of the collection of the print substrate, based on the comparison. Adjusting the velocity of the collection may comprise adjusting the rotational velocity of the collecting roller. The adjusting the velocity of the collection of the print substrate may alter the velocity of the print substrate through the post-processing zone, and may control the tension of the print substrate.

According to examples described herein, the printed substrate 14 may be advanced uniformly through the post-processing zone 32. Uniform advancement of the printed substrate 14 through the post-processing zone 32 may allow the printed substrate 14 to be uniformly dried and/or cured, which may allow the distance between the post-processing plate 28 and the substrate 14 to be minimised. This may increase the curing and/or drying capability of the printer 10.

Uniform advancement of the printed substrate 14 through the post-processing zone 32 may provide more design freedom in the arrangement of the apertures 30 in the plate 28 of the post-processing apparatus, because the arrangement of apertures 30 may not be influenced by the distance between the plate 28 and the substrate 14.

Furthermore, uniform advancement of the printed substrate 14 through the post-processing zone may permit the collection mechanism to drive the collecting roller in a continuous motion, which may allow the collection mechanism to drive collecting rollers with increased weight and radius, because accelerations and decelerations of the driving of the collecting rollers are minimised.

1. A print substrate transport device comprising:
a print substrate supply mechanism configured to advance print substrate to a printing zone in a discontinuous motion; and
a tensioner provided downstream of the print printing zone,
wherein the tensioner is configured to guide a path of the print substrate from the printing zone to a post-processing zone, to control tension in the print substrate in the post-processing zone, and to convert the discontinuous motion of the substrate to continuous motion.

2. The print substrate transport device of claim 1, further comprising a print substrate collection mechanism configured to collect the print substrate in a continuous motion, wherein the print substrate collection mechanism comprises a collecting roller, wherein the collecting roller is configured to rotate in a continuous motion to collect the print substrate.

3. The print substrate transport device of claim 2, wherein the print substrate supply mechanism comprises a supply roller, wherein the motion of the supply roller is configured to change between a rotating state and a non-rotating state to provide the print substrate in a non-continuous motion, wherein in the non-rotating state motion of the print substrate in the printing zone is prevented, wherein the print substrate is provided between the supply roller and the collecting roller in a continuous path.

4. The print substrate transport device claim 3, wherein the tensioner comprises an idle roller to guide the path of the substrate, wherein the idle roller is biased to a first position when the supply roller is in the rotating state, and wherein the tensioner is configured to move under a force provided by the collecting roller when the supply roller is in the non-rotating state.

5. The print substrate transport device of claim 4, wherein the idle roller is biased by any one of a spring, a gas spring or a pneumatic actuator.

6. The print substrate transport device of claim 1, wherein the tensioner comprises a roller to guide the path of the substrate, wherein the tensioner is motorised and configured to move to control the tension in the print substrate.

7. A printing system comprising:
a print substrate supply mechanism configured to supply print substrate to a printing zone in a discontinuous motion;
a print engine configured to print onto the substrate in the printing zone;
a post-processing apparatus configured to dry and/or cure the printed substrate in a post-processing zone;
a tensioner provided on a print substrate path downstream of the printing zone,
wherein the tensioner is configured to guide the path of the print substrate in the post-processing zone, to control tension in the print substrate in the post-processing zone, and to convert the discontinuous motion of the substrate to a continuous motion through the post-processing zone.

8. The printing system of claim 7, wherein the post-processing apparatus comprises a plate, and wherein the tensioner is configured to guide the printed substrate to move parallel to the plate in the post-processing zone.

9. The printing system of claim 8, wherein the tensioner is configured to move in a direction parallel to the plate.

10. The printing system of claim 7, wherein the printing system comprises a print substrate collection mechanism configured to collect the printed substrate in a continuous motion and a sensor configured to measure a position and/or velocity of the print substrate in the post-processing zone, and wherein the printing system further comprises a controller configured to control a velocity of the continuous print collection mechanism according to the measured position and/or velocity.

11. The printing system of claim 10, wherein the sensor is provided in the tensioner.

12. A print substrate transport method comprising
supplying a print substrate to a printing zone in a discontinuous motion; and
controlling a tension of the print substrate on a path downstream of the printing zone and converting the motion of the substrate from the discontinuous motion to a continuous motion.

13. The print substrate transport method of claim 12, comprising determining a velocity of the continuous motion of the print substrate and comparing the measured velocity with a predetermined velocity.

14. The print substrate transport method of claim 13, comprising collecting the print substrate in the continuous motion and adjusting a velocity of the continuous motion of collecting the print substrate based on the comparison between the measured velocity and the predetermined velocity.

15. The print substrate transport method of claim 13, comprising controlling the tension of the print substrate based on the comparison between the measured velocity and the predetermined velocity.
